(19) United States
(12) Patent Application Publication
(10) Pub. No.: US 2018/0131019 A1
(43) Pub. Date: May 10, 2018

(54) FUEL CELL VEHICLE AND METHOD FOR CONTROLLING FUEL CELL VEHICLE

(71) Applicants: KABUSHIKI KAISHA TOYOTA JIDOSHOKKI, Kariya-shi (JP); TOYOTA JIDOSHA KABUSHIKI KAISHA, Toyota-shi (JP)

(72) Inventor: Naoya TOMIMOTO, Kariya-shi (JP)

(73) Assignees: KABUSHIKI KAISHA TOYOTA JIDOSHOKKI, Kariya-shi (JP); TOYOTA JIDOSHA KABUSHIKI KAISHA, Toyota-shi (JP)

(21) Appl. No.: 15/797,422

(22) Filed: Oct. 30, 2017

(30) Foreign Application Priority Data
Nov. 4, 2016 (JP) 2016-216687

(51) Int. Cl. H01M 8/04313; H01M 8/24

(52) U.S. Cl. CPC H01M 8/04313; H01M 2250/20; H01M 8/24

(57) ABSTRACT

A fuel cell vehicle includes an in-vehicle electric load, a fuel cell stack, which is electrically connected to the in-vehicle electric load, a power storage device, which is electrically connected to the fuel cell stack so as to be electrically connected in parallel to the in-vehicle electric load, a state-of-charge sensor, which is configured to detect a state of charge of the power storage device, and circuitry that is configured to switch, in multiple stages, a power generated by the fuel cell stack based on the state of charge of the power storage device detected by the state-of-charge sensor. The circuitry is configured to set, at least at one of the multiple stages, a power generation command value in accordance with selected one of a plurality of operation modes that have different power generation command values.

### BACKGROUND

The present invention relates to a fuel cell vehicle equipped with a fuel cell system and a method for controlling the fuel cell vehicle.

Vehicles (for example, forklifts and other industrial vehicles) equipped with fuel cell systems have been in practical use. In a typical fuel cell system, fluctuations in the generated power cause deterioration of the fuel cell stack. Thus, to prevent deterioration of the fuel cell stack, it is preferable to minimize the fluctuations in generated power so that constant power is generated. A fuel cell system has been known that controls the power generated by the fuel cell stack in three predetermined stages without changing the power continuously. In such a system, a capacitor is connected in parallel with electric loads, which are connected to the fuel cell stack. When the power generated by the fuel cell stack exceeds the power required by the in-vehicle electric loads, the surplus power is used to charge the capacitor. In contrast, when the generated power falls below the power required by the electric loads, the power corresponding to the insufficiency is discharged from the capacitor. In relation to this type of technology, Japanese Laid-Open Patent Publication No. 2014-82056 discloses a fuel cell system mounted on a vehicle. That is, when the open-circuit voltage of the capacitor falls below a predetermined threshold value while the fuel cell stack is generating a predetermined intermediate power, the power generated by the fuel cell stack is switched from the intermediate power to a predetermined maximum power. In order to optimally compensate for the power insufficiency with the power discharged from the capacitor at the time of switching, the predetermined threshold value is determined based on the predetermined maximum power, the predetermined intermediate power, the capacity of the capacitor, the allowable minimum voltage of the capacitor, and the rate of increase of the generated power from the predetermined intermediate power to the predetermined maximum power.

In the fuel cell system, as the power generated by the fuel cell stack increases, the power consumption for driving accessories (for example, the water pump for cooling the fuel cell stack, the radiator fan for cooling the fuel cell stack, the compressor for supplying air) increases, which reduces the efficiency of the fuel cell system.

### SUMMARY

Accordingly, it is an objective of the present invention to provide a fuel cell vehicle and a method for controlling the fuel cell vehicle that allow operations emphasizing the efficiency to be performed, while ensuring a certain level of vehicle performance.

To achieved the foregoing objective and in accordance with a first aspect of the present invention, a fuel cell vehicle is provided that includes an in-vehicle electric load, a fuel cell stack, which is electrically connected to the in-vehicle electric load, a power storage device, which is electrically connected to the fuel cell stack so as to be electrically connected in parallel to the in-vehicle electric load, a state-of-charge sensor, which is configured to detect a state of charge of the power storage device, and circuitry that is configured to switch, in multiple stages, a power generated by the fuel cell stack based on the state of charge of the power storage device detected by the state-of-charge sensor. The circuitry is configured to set, at least at one of the multiple stages, a power generation command value in accordance with selected one of a plurality of operation modes that have different power generation command values.

In accordance with a second aspect of the present invention, a fuel cell vehicle is provided that includes an in-vehicle electric load, a fuel cell system including a fuel cell stack, which is electrically connected to the in-vehicle electric load, a power storage device, which is electrically connected to the fuel cell stack so as to be electrically connected in parallel to the in-vehicle electric load, a state-of-charge sensor, which is configured to detect a state of charge of the power storage device, and circuitry that is configured to control the fuel cell system to switch, in multiple stages, a power generated by the fuel cell stack based on the state of charge of the power storage device detected by the state-of-charge sensor. The in-vehicle electric load is configured to be operated in selected one of a plurality of operation modes. Power generation command values are defined that respectively correspond to the operation modes and are different from each other. The circuitry is configured to set, at least at one of the multiple stages, one of the power generation command values that corresponds to the selected one of the operation modes and to control the fuel cell system based on the set power generation command value.

In accordance with a third aspect of the present invention, a method for controlling a fuel cell vehicle is provided. The fuel cell vehicle includes an in-vehicle electric load, a fuel cell stack, which is electrically connected to the in-vehicle electric load, and a power storage device, which is electrically connected to the fuel cell stack so as to be electrically connected in parallel to the in-vehicle electric load. The method includes: detecting a state of charge of the power storage device; switching, in multiple stages, a power generated by the fuel cell stack based on the detected state of charge of the power storage device; and setting, at least at one of the multiple stages, a power generation command value in accordance with selected one of a plurality of operation modes that have different power generation command values.

Other aspects and advantages of the present invention will become apparent from the following description, taken in conjunction with the accompanying drawings, illustrating by way of example the principles of the invention.

### BRIEF DESCRIPTION OF THE DRAWINGS

The invention, together with objects and advantages thereof, may best be understood by reference to the following description of the presently preferred embodiments together with the accompanying drawings in which:

FIG. 1 is a schematic side view of a fuel cell forklift according to one embodiment;

FIG. 2 is a schematic diagram of a fuel cell system and a vehicle system;

FIG. 3 is an explanatory flowchart of an operation;

FIG. 4 is an explanatory diagram showing switching among power generation stop, low power generation, medium power generation, high power generation;

FIG. 5 is a graph showing the relationship between the power generated by the fuel cell stack and the system efficiency; and

FIG. 6 is a graph showing the relationship between the current density and the cell voltage.

### DETAILED DESCRIPTION

A forklift according to one embodiment of the present invention will now be described with reference to the drawings.

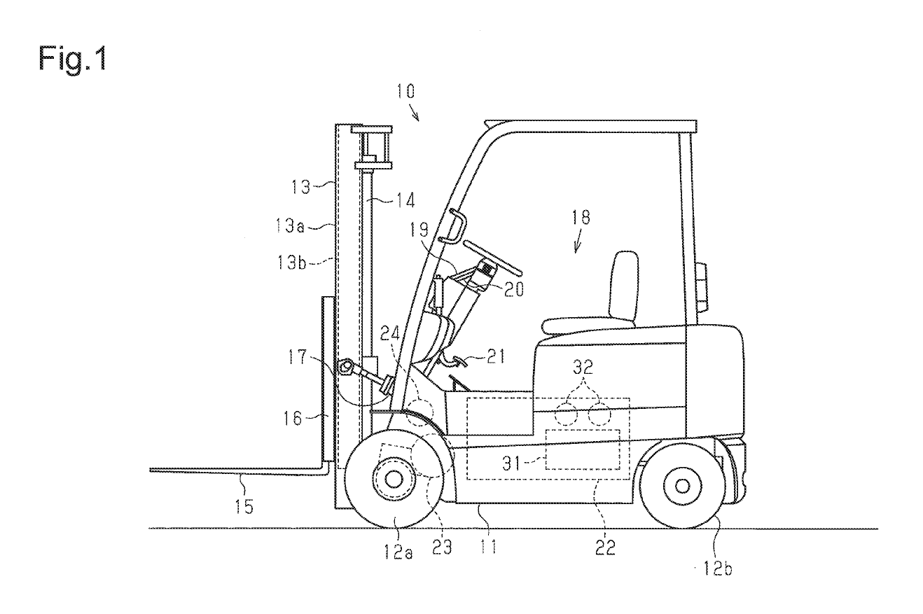

As shown in FIG. 1, a fuel cell forklift 10 has drive wheels (front wheels) 12a in the front lower part of a vehicle body 11 and steered wheels (rear wheels) 12b in the rear lower part of the vehicle body 11. An upright mast 13 is provided in front of the vehicle body 11. The mast 13 is composed of a pair of left and right outer masts 13a and an inner mast 13b. The outer masts 13a are supported so as to tilt back and forth with respect to the vehicle body 11. The inner mast 13b slides up and down with respect to the outer masts 13a. A lift cylinder 14 is arranged at the rear of each outer mast 13a. A lift bracket 16 provided with a fork 15 is supported inside the inner mast 13b so as to be movable up and down. The fork 15 is raised and lowered together with the lift bracket 16 by the extension and retraction of the lift cylinders 14.

Each of the right and left tilt cylinders 17 has a proximal end, which is pivotally coupled to the vehicle body 11, and a distal end, which is pivotally coupled to the side of the corresponding outer mast 13a. The mast 13 is tilted forward or rearward when the tilt cylinders 17 are extended or retracted.

A lift lever 19 and a tilt lever 20 are arranged at the front part in an operator cab 18. The lift lever 19 is a lever for raising and lowering the fork 15, and the tilt lever 20 is a lever for tilting the mast 13 forward or rearward. An accelerator pedal 21 is provided at the lower part in the operator cab 18. The vehicle speed is controlled in accordance with the operated amount of the accelerator pedal 21.

The vehicle body 11 mounts a fuel cell system 22, a traveling motor 23, and a cargo handling motor 24. The fuel cell system 22 drives the traveling motor 23, which in turn drives the drive wheels 12a. Specifically, the output shaft of the traveling motor 23 is coupled to the rotary shafts of the drive wheels 12a via a speed reducer (not shown). When the traveling motor 23 drives and rotates its output shaft, the rotation of the output shaft rotates the rotary shafts of the drive wheels 12a, so that the drive wheels 12a are driven.

Also, the fuel cell system 22 drives the cargo handling motor 24, which in turn drives a cargo handling pump (not shown). The driving of the cargo handling pump causes the lift cylinder 14 and the tilt cylinders 17 to extend or retract, so that the fork 15 is vertically moved and tilted. That is, the cargo handling motor 24 serves as a hydraulic drive source for the lift cylinder 14 and the tilt cylinders 17.

As described above, the fuel cell system 22 is used as a power source for the cargo handling motor 24 and the traveling motor 23.

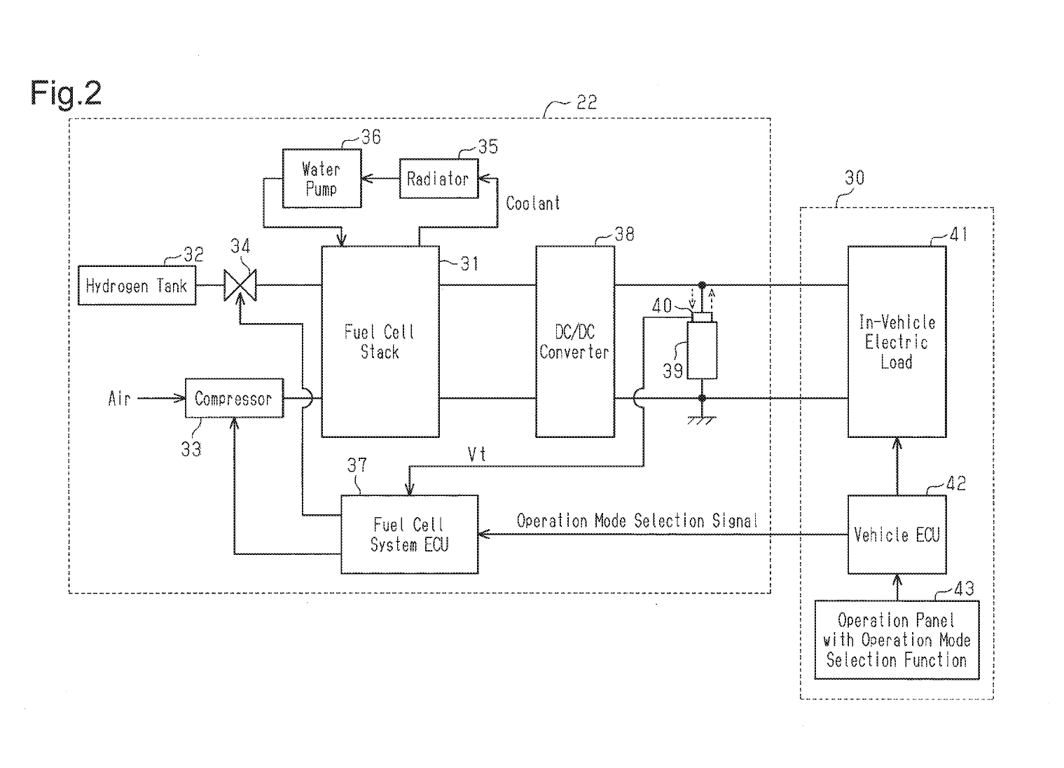

Next, with reference to FIG. 2, the fuel cell system 22 and a vehicle system 30 will be described.

As shown in FIG. 2, the fuel cell system 22 includes a fuel cell stack 31, a hydrogen tank 32, a compressor 33, an electromagnetic valve 34, a radiator 35, a water pump 36, an electronic control unit (hereinafter referred to as a fuel cell system ECU) 37, a DC/DC converter 38, a capacitor 39 as a power storage device, and a terminal voltage measuring device 40. The vehicle system 30 has an in-vehicle electric load 41, an electronic control unit (hereinafter referred to as a vehicle ECU) 42, and an operation panel 43 with an operation mode selection function. The operation panel 43 includes a display. The in-vehicle electric load 41 represents electric devices driven by the power from the fuel cell system 22 and includes the traveling motor 23 and the cargo handling motor 24. Each of the fuel cell system ECU 37 and the vehicle ECU 42 may include a microcomputer and/or dedicated hardware (application specific integrated circuit: ASIC) for executing at least part of various procedures. That is, each of the fuel cell system ECU 37 and the vehicle ECU 42 may be circuitry including 1) one or more dedicated hardware circuits such as an ASIC, 2) one or more processors (microcomputers) that operate according to a computer program (software), or 3) a combination thereof.

The fuel cell stack 31 in the fuel cell system 22 is constituted by stacking a plurality of cells, and the cells are electrically connected in series to each other. The hydrogen tank 32 is capable of supplying hydrogen gas to the fuel cell stack 31. The compressor 33 is capable of supplying air containing oxygen to the fuel cell stack 31. Hydrogen supplied from the hydrogen tank 32 and oxygen in the air supplied from the compressor 33 cause a chemical reaction in the fuel cell stack 31, which generates electric energy.

The electromagnetic valve 34 is provided in a pipe connecting the fuel cell stack 31 and the hydrogen tank 32 to each other. The electromagnetic valve 34 adjusts the amount of hydrogen gas supplied to the fuel cell stack 31. The electromagnetic valve 34 and the compressor 33 are controlled by the fuel cell system ECU 37.

The fuel cell stack 31 is connected to a coolant circulation route, in which the radiator 35 and the water pump 36 are provided. The radiator 35 includes a radiator fan (not shown). Circulation of coolant through the circulation route cools the fuel cell stack 31. That is, the fuel cell stack 31 is prevented from overheating. The compressor 33, the water pump 36, the radiator fan, and the like are accessories in the fuel cell system 22 and are driven by the power output from the fuel cell stack 31 or the capacitor 39.

The fuel cell stack 31 is connected to the capacitor 39 via the DC/DC converter 38. The capacitor 39 is connected to the in-vehicle electric load 41. That is, the fuel cell stack 31 is electrically connected to the in-vehicle electric load 41 via the DC/DC converter 38 and the capacitor 39. The DC power generated by the fuel cell stack 31 is stepped down to a predetermined voltage by the DC/DC converter 38 and then delivered to the in-vehicle electric load 41 via the capacitor 39.

The in-vehicle electric load 41 includes the traveling motor 23 and cargo handling motor 24, which are driven based on operation of the accelerator pedal 21, the lift lever 19, and the tilt lever 20, which serve as operating members. That is, the in-vehicle electric load 41 includes the cargo handling motor 24 and the traveling motor 23 for driving the axle. When the cargo handling motor 24 and the traveling motor 23 are driven by the power supplied from the fuel cell system 22, the cargo handling operation and the traveling operation are executed.

The capacitor 39 is electrically connected in parallel with the in-vehicle electric load 41 (the traveling motor 23, the cargo handling motor 24, and the like) and is also electrically connected to the fuel cell stack 31. When the power generated by the fuel cell stack 31 exceeds the power required by the in-vehicle electric load 41 (the traveling motor 23, the cargo handling motor 24, and the like), the surplus power is used to charge the capacitor 39. In contrast, when the generated power falls below the required power, the power corresponding to the insufficiency is discharged from the capacitor 39. A terminal voltage measuring device 40 is attached to the capacitor 39. The terminal voltage measuring device 40 measures the terminal voltage Vt of the capacitor 39.

The fuel cell system ECU 37 estimates the state of charge (SOC) of the capacitor 39 based on parameters including the terminal voltage Vt of the capacitor 39 measured by the terminal voltage measuring device 40 and the internal resistance of the capacitor 39. In the present embodiment, the terminal voltage measuring device 40 and the fuel cell system ECU 37 constitute a state-of-charge detection means or a state-of-charge sensor, which detects the SOC of the capacitor 39. Based on the estimated SOC of the capacitor 39, the fuel cell system ECU 37 controls the opening degree of the electromagnetic valve 34 and the displacement of the compressor 33 to adjust the amounts of the hydrogen and oxygen supplied to the fuel cell stack 31, thereby controlling the power generated by the fuel cell stack 31. Specifically, based on the SOC of the capacitor 39, the fuel cell system ECU 37, which serves as a control means, switches the power generated by the fuel cell stack 31 among three stages, which are a predetermined minimum power (low power generation), a predetermined intermediate power (medium power generation), and a predetermined maximum power (high power generation). Such control of the power generation of the fuel cell stack 31 in the three predetermined stages without changing it continuously suppresses the fluctuation of the generated power, so that the deterioration of the fuel cell stack 31 is reduced.

The vehicle ECU 42 in the vehicle system 30 controls the entire vehicle system 30, which includes the traveling motor 23 and the cargo handling motor 24. The operation panel 43 is equipped with an operation mode selection switch operated by the operator (occupant), and the operator can select any of a high load mode, a middle load mode, and a low load mode, which have different power generation command values, using the operation mode selection switch. The vehicle ECU 42 controls the in-vehicle electric load 41 (the traveling motor 23 and the cargo handling motor 24) in accordance with the selected operation mode.

The fuel cell system ECU 37 and the vehicle ECU 42 are connected to each other. Specifically, the fuel cell system ECU 37 and the vehicle ECU 42 can communicate with each other through a communication means such as serial communication or CAN communication. That is, the fuel cell system ECU 37 and the vehicle ECU 42 share information through communication. The fuel cell system ECU 37 and the vehicle ECU 42 may also communicate with each other via analog signals.

The vehicle ECU 42 and the operation panel 43 are connected to each other. An operation signal including an operation mode selection signal is sent from the operation panel 43 to the vehicle ECU 42 and is sent to the fuel cell system ECU 37 via the vehicle ECU 42.

In this manner, the operation mode of the fuel cell forklift 10 can be changed by using the operation panel 43, and the operator can arbitrarily select the operation mode in accordance with the purpose. Specifically, three operation modes are provided, which are the high load mode, middle load mode, and low load mode. Even in the same operation, the power that the fuel cell stack 31 is required to generate changes depending on the selected mode.

Operation of the fuel cell forklift 10 having the foregoing configuration will now be described.

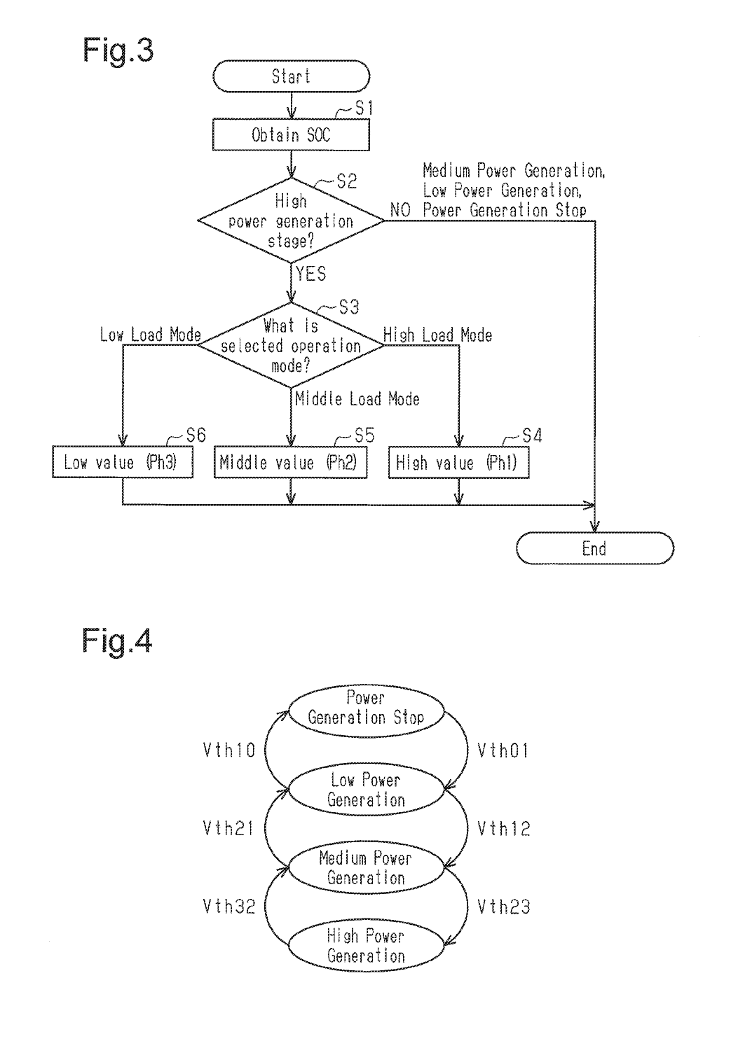

FIG. 3 shows a procedure executed by the fuel cell system ECU 37. As shown in FIG. 3, the fuel cell system ECU 37 obtains the SOC of the capacitor 39 at step S1. Then, as shown in FIG. 4, the fuel cell system ECU 37 controls the power generation of the fuel cell stack 31 based on the SOC of the capacitor 39 in a step-by-step manner. Specifically, when the SOC of the capacitor 39 falls below a threshold value Vth01 in a state where the fuel cell stack 31 is not generating power, the fuel cell system ECU 37 controls the power generation to be the low power generation. When the SOC exceeds a threshold value Vth10, which is greater than the threshold value Vth01, in the low power generation state, the fuel cell stack 31 stops generating power. When the SOC falls below a threshold value Vth12, which is less than the threshold value Vth01, in the low power generation state, the fuel cell system ECU 37 controls the power generation to be the medium power generation. When the SOC exceeds a threshold value Vth21, which is greater than the threshold value Vth12, in the medium power generation state, the fuel cell system ECU 37 controls the power generation to be the low power generation. When the SOC falls below a threshold value Vth23, which is less than the threshold value Vth12, in the medium power generation state, the fuel cell system ECU 37 controls the power generation to be the high power generation. When the SOC exceeds a threshold value Vth32, which is greater than the threshold value Vth23, in the high power generation state, the fuel cell system ECU 37 controls the power generation to be the medium power generation.

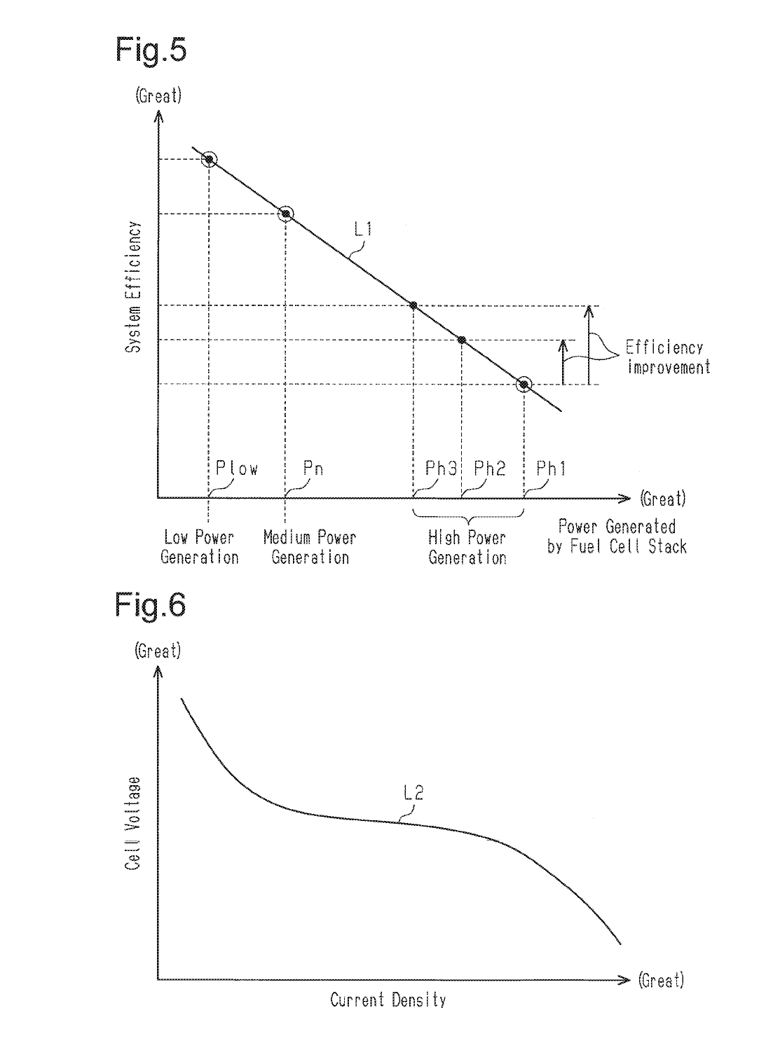

In the graph of FIG. 5, the horizontal axis represents the power generated by the fuel cell stack, and the vertical axis represents the system efficiency. The power generated by the low power generation is defined as Plow, the power generated by the medium power generation is defined as Pn. The generated power Pn of the medium power generation is greater than the generated power Plow of the low power generation.

The fuel cell system ECU 37 determines whether the generated power should be switched to a high power generation region (a high power generation stage) at step S2 of FIG. 3. If the generated power should be switched to the high power generation region, the fuel cell system ECU 37 proceeds to step S3. If it is not necessary to switch the generated power to the high power generation region, the fuel cell system ECU 37 switches the generated power to one of the medium power generation, the low power generation, and the power generation stop as described with reference to FIG. 4.

At step S3, the fuel cell system ECU 37 determines whether the operation mode selected by the operation mode selection switch is the high load mode, the middle load mode, or the low load mode. If the operation mode is the high load mode, the fuel cell system ECU 37 proceeds to step S4. If the operation mode is the middle load mode, the fuel cell system ECU 37 proceeds to step S5. If the operation mode is the low load mode, the fuel cell system ECU 37 proceeds to step S6.

If the operation mode is the high load mode, the fuel cell system ECU 37 sets a generated power value to a relatively high first power generation command value Ph1 (see FIG. 5) at step S4.

If the operation mode is the middle load mode, the fuel cell system ECU 37 sets the generated power value to a medium second power generation command value Ph2 (see FIG. 5) at step S5. That is, the second power generation command value Ph2 is less than the first power generation command value Ph1.

Further, if the operation mode is the low load mode, the fuel cell system ECU 37 sets the generated power value to a relatively low third power generation command value Ph3 (see FIG. 5) at step S6. That is, the third power generation command value Ph3 is less than the second power generation command value Ph2.

As described above, at the high power generation stage, which is one of the multiple stages, the fuel cell system ECU 37 sets the power generation command value according to the operation mode selected from the three operation modes having different power generation command values. The fuel cell system ECU 37 controls the fuel cell system 22, specifically the compressor 33 and the electromagnetic valve 34, in accordance with the set power generation command value to adjust the power generated by the fuel cell stack 31 to the required value.

In the graph of FIG. 6, the horizontal axis represents the current density of the cell of the fuel cell stack, and the vertical axis represents the cell voltage of the fuel cell stack. The characteristic line L2 shows that the cell voltage decreases as the current density increases. As described above, in the relationship between the current density and the cell voltage, the greater the current density, the lower the cell voltage becomes and the greater the power loss in the fuel cell stack becomes. This power loss is mainly converted into heat. In order to take measures against the heat generation at the high power generation stage, it is necessary to operate devices (accessories) such as the water pump 36 and the radiator fan under high load. That is, the higher the cell current density, the lower the cell voltage becomes and the greater the heat generation becomes as shown in FIG. 6. It is thus necessary to cool the fuel cell stack 31 by operating the water pump 36 and the radiator fan under high load. In addition, it is necessary to operate the compressor 33 under higher load as the current density increases. Therefore, all the accessories operate under high load, and the system efficiency decreases at the time of the high power generation as shown in FIG. 5.

As a result, as represented by the characteristic line L1 in FIG. 5, the greater the generated power, the lower the system efficiency becomes. In other words, the greater the generated power, the lower the efficiency of the fuel cell stack 31 becomes, which increases the consumption of hydrogen serving as fuel.

In the present embodiment, the efficiency reduction is suppressed in the case where the generated power value is set to the second power generation command value Ph2 (Ph2<Ph1) as compared to the case where the generated power value is set to the first power generation command value Ph1. As compared with the case where the generated power value is set to the second power generation command value Ph2, the efficiency reduction is suppressed in the case where the generated power value is set to the third power generation command value Ph3 (Ph3<Ph2<Ph1). By lowering the value of the generated power in this manner, that is, by lowering the generated power, the efficiency reduction is suppressed. That is, in the low load operation mode, it is possible to suppress the power generated by the fuel cell stack 31, and it is possible to improve the efficiency by reducing the operation of the devices (accessories) such as the compressor 33, the water pump 36, and the radiator fan. Also, it is possible to prevent the fuel cell stack 31 from overheating by decreasing the amount of heat generated by the fuel cell stack 31. In this manner, the operation mode can be changed in accordance with the load. Also, by setting the generated power such that a certain level of operation is ensured at each operation mode, the efficiency reduction of the system is suppressed.

The above-described embodiment has the following advantages.

(1) A fuel cell vehicle, in particular, a fuel cell industrial vehicle exemplified by the fuel cell forklift 10 includes the fuel cell stack 31, which is electrically connected to the in-vehicle electric load 41, and the capacitor 39, which is electrically connected in parallel with the in-vehicle electric load 41 and is also electrically connected to the fuel cell stack 31. Further, the fuel cell forklift 10 includes the terminal voltage measuring device 40 and the fuel cell system ECU 37, which serve as a state-of-charge detection means. The SOC of the capacitor 39 is detected by the terminal voltage measuring device 40 and the fuel cell system ECU 37. The fuel cell system ECU 37, which serves as a control means, switches the power generated by the fuel cell stack 31 in three stages based on the SOC of the capacitor 39. At the high power generation stage, which is one of the three stages, the fuel cell system ECU 37 sets the power generation command value in accordance with the operation mode selected from the three operation modes having different power generation command values.

At the high power generation stage, the efficiency decreases as the generated power increases. However, in the present embodiment, at the high power generation stage, different generation command values are set in accordance with the selected operation mode. Therefore, when a smaller power generation command value is set, although the generated power is limited, the efficiency of the fuel cell system is improved. That is, in the low load operation mode, it is possible to suppress the power generated by the fuel cell stack 31, and it is possible to improve the efficiency by reducing the operation of the devices (accessories) such as the compressor 33, the water pump 36, and the radiator fan. Also, it is possible to prevent the fuel cell stack 31 from overheating by decreasing the amount of heat generated by the fuel cell stack 31. As a result, it is possible to provide a fuel cell forklift 10 that allows operations emphasizing the efficiency while ensuring a certain level of vehicle performance as a fuel cell forklift.

(2) One of the multiple stages is the high power generation stage, in which the fuel cell system ECU 37 sets the power generation command value in accordance with the operation mode. Thus, at the high power generation stage, in which the system efficiency decreases, the efficiency can be improved by setting a smaller generation command value.

(3) The operation mode is selected using the operation panel (display) 43, which is an operating means or an operating device. This configuration is favorable in reflecting the intention of the operator on operations. For example, when relatively low load operations are performed successively without the need for using the high load mode or when efficient operations are demanded to extend the operating time of the vehicle, the operator is allowed to select the middle load mode or the low load mode, which emphasizes the efficiency.

The present invention is not limited to the above described embodiment, but may be modified as follows.

The fuel cell system ECU 37 switches the power generated by the fuel cell stack 31 in three stages based on the SOC of the capacitor 39. However, the number of the stages may be two or greater than three. In short, the configuration may be changed as long as the power generated by the fuel cell stack 31 is switched in multiple stages based on the SOC of the capacitor.

At one of the multiple stages, the power generation command value is set in accordance with the operation mode selected from the three operation modes of different power generation command values. However, the power generation command value may be set in accordance with the operation mode selected from the three operation modes of different power generation command values in any of the multiple stages. In short, it is only necessary to set the power generation command value in accordance with the selected operation mode at least at one of the multiple stages.

The number of the operation modes having different power generation command values is three. However, the number of the operation modes may be two or more than three. In short, it is only necessary to set the power generation command value in accordance with the operation mode selected from multiple operation modes having different power generation command values.

The operation panel (display) is used as the means for selecting the operation mode, but other tools may be used instead.

The operator selects the operation mode using the operation panel (display) 43, but the present invention is not limited to this. For example, the fuel cell forklift 10 may be provided with a detecting means (a position information sensor) for detecting or obtaining the position information of the vehicle, and the operation mode may be automatically selected based on this position information. As an example, the low load mode is selected at a location with, for example, a vehicle speed limit. If it is detected that the vehicle has entered a specific location based on the position information, a specific operation mode, for example, the low load mode is selected. Additionally, in the case of automation, the operation mode may be selected by a command from the control tower.

Further, the fuel cell forklift 10 may be provided with a detecting means such as a cargo weight sensor for detecting the information of the cargo weight, and the operation mode may be automatically selected based on this cargo weight information. As an example, for example, when conveying a heavy cargo, an operation mode with a higher power generation command value may be selected.

The SOC of the capacitor 39 is estimated based on the terminal voltage Vt of the capacitor 39, but the present invention is not limited thereto, and the SOC of the capacitor 39 may be detected by another method. For example, the SOC of the capacitor 39 may be detected by integrating the current input to and output from the capacitor 39.

As the power storage device, the capacitor 39 is used. However, instead of this, a rechargeable battery or the like may be used as the power storage device.

In the above-illustrated embodiment, the present invention is embodied as a forklift, which is an industrial vehicle. However, the present invention may be embodied as other types of industrial vehicles. For example, the present invention may be employed in a towing vehicle or the like used at an airport or the like. Alternatively, the present invention may be employed in vehicles other than industrial vehicles, for example, passenger cars and buses.

Therefore, the present examples and embodiments are to be considered as illustrative and not restrictive and the invention is not to be limited to the details given herein, but may be modified within the scope and equivalence of the appended claims.

1. A fuel cell vehicle comprising:
an in-vehicle electric load;
a fuel cell stack, which is electrically connected to the in-vehicle electric load;
a power storage device, which is electrically connected to the fuel cell stack so as to be electrically connected in parallel to the in-vehicle electric load;
a state-of-charge sensor, which is configured to detect a state of charge of the power storage device; and
circuitry that is configured to switch, in multiple stages, a power generated by the fuel cell stack based on the state of charge of the power storage device detected by the state-of-charge sensor,
wherein the circuitry is configured to set, at least at one of the multiple stages, a power generation command value in accordance with selected one of a plurality of operation modes that have different power generation command values.

2. The fuel cell vehicle according to claim 1, wherein
one of the multiple stages is a high power generation stage, and
the circuitry is configured to set, at the high power generation stage, the power generation command value in accordance with the operation mode.

3. The fuel cell vehicle according to claim 1, comprising an operating device that is used to select the operation mode and configured to be operated by an operator.

4. The fuel cell vehicle according to claim 1, wherein
the operation modes include at least a first mode and a second mode, in which the in-vehicle electric load is operated under a smaller load than in the first mode, and
the power generation command value corresponding to the first mode is greater than the power generation command value corresponding to the second mode.

5. A fuel cell vehicle comprising:
an in-vehicle electric load;
a fuel cell system including a fuel cell stack, which is electrically connected to the in-vehicle electric load;
a power storage device, which is electrically connected to the fuel cell stack so as to be electrically connected in parallel to the in-vehicle electric load;
a state-of-charge sensor, which is configured to detect a state of charge of the power storage device; and
circuitry that is configured to control the fuel cell system to switch, in multiple stages, a power generated by the fuel cell stack based on the state of charge of the power storage device detected by the state-of-charge sensor, wherein
the in-vehicle electric load is configured to be operated in selected one of a plurality of operation modes,
power generation command values are defined that respectively correspond to the operation modes and are different from each other, and
the circuitry is configured to set, at least at one of the multiple stages, one of the power generation command values that corresponds to the selected one of the operation modes and to control the fuel cell system based on the set power generation command value.

6. A method for controlling a fuel cell vehicle, the fuel cell vehicle including
an in-vehicle electric load;
a fuel cell stack, which is electrically connected to the in-vehicle electric load; and
a power storage device, which is electrically connected to the fuel cell stack so as to be electrically connected in parallel to the in-vehicle electric load,
the method comprising:
detecting a state of charge of the power storage device;
switching, in multiple stages, a power generated by the fuel cell stack based on the detected state of charge of the power storage device; and
setting, at least at one of the multiple stages, a power generation command value in accordance with selected one of a plurality of operation modes that have different power generation command values.
